(19) United States
(12) Patent Application Publication
(10) Pub. No.: US 2006/0137027 A1
(43) Pub. Date: Jun. 22, 2006

(54) Anti-patch software pirating

(76) Inventors: Julian Rogers, Goleta, CA (US); Mark Ellery Ogram, Tucson, AZ (US)

Correspondence Address: Mark E. Ogram, 7454 E. Broadway # 203, Tucson, AZ, 85710, US

(21) Appl. No.: 11/092,224

(22) Filed: Mar. 28, 2005

Related U.S. Application Data
(63) Continuation-in-part of application No. 11/013,825, filed on Dec. 16, 2004.

(51) Int. Cl. H04N 7/16

(52) U.S. Cl. 726/29

(57) ABSTRACT

A system for the protection of software from unauthorized copying in which the downloading process changes the overall length of the executable software. This process allows the production of differing versions of the same software. Because of the variety of executable lengths, it becomes impractical for the software “pirate” to create software patches to avoid any security components within the software package.

This is a continuation-in-part of United States patent application Ser. No. 11/013,825, filed on Dec. 16, 2004, and entitled, “Anti-Pirating System”.

### BACKGROUND OF THE INVENTION

This invention relates generally to software and more particularly to systems which restrict the unauthorized copying of software.

“Pirating” of software is the un-licensed use of the software. In some countries, it has been estimated that in the range of 60-85% of all software is a “pirated” copy. Obviously, each un-licensed or pirated copy of a software program takes money away from the developer of the software; this often runs into the billions of dollars.

The creation of pirated copies is typically done through one of two different techniques. The first technique is that a single authorized or licensed copy is purchased and that diskette is shared with many other unauthorized users who download the software before passing the diskette along to others; the second technique is that a single authorized copy is obtained and production level copies are made and are sold to often unsuspecting users.

In either case, the very nature of the modern software distribution chain is partly to blame. Software programs are easily copied onto other medium or are easily distributed over the Internet.

While some upper level complex programs make it possible to go through a formal licensing and monitoring procedure, the vast majority of software programs do not have either the economic background nor the face-to-face relationship to justify the costs and economic burden in creating either a formal licensing or the monitoring that is required to prevent pirating of the software.

Another problem associated with “pirating” or the unauthorized use of software is the use of software “patches” which are selectively applied to avoid the security components that the targeted software is using. In this situation, the “pirate” obtains a legitimate copy of the software and proceeds to identify the location of the security components within the software. Once these locations are identified, the “pirate” creates a software “patch” which jumps over the security components; thereby neutralizing the software's built in protection.

It is clear there is a need for an effective method to curtail the unauthorized copying of software.

### SUMMARY OF THE INVENTION

The invention is a software distribution system which uses a removable medium for distribution of the software programs. In this context, a removable medium includes any of a variety of mechanisms well known to those of ordinary skill in the art, including, but not limited to: Compact Discs (CDs); floppy discs; and magnetic cards.

In the preferred embodiment, a primary software program and a secondary software program are used. For purposes of example only, the primary software program is the software that is to be used, such as a word processor or a spread sheet. The primary software program is to be downloaded from the storage medium (such as a CD) onto the memory within the computer. Often, the copy of the software stored on the memory of the computer is used in the operation of the primary software; but, in some embodiments, the copy found on the medium (i.e. the CD) is used by the computer in operation.

Within the preferred embodiment, the secondary software program is used to establish an identifier. In operation, often, but not always, the secondary software is downloaded onto the memory of the computer and is run from there. The secondary software establishes an identifier which, in the preferred embodiment, incorporates an identification of the computer as well as the primary software. This is ideally done by combining the serial number from both the computer and the primary software either as a single run-on combination or as two components.

Once the secondary software has created the identifier, the secondary software program then erases itself. This action, erasing the secondary software, assures that a second “key” cannot be made. Hence, should a purchaser of the software want to share the primary software with someone else, the secondary software no longer exists and therefore a second key cannot be made.

This identifier (or key) is used by the primary software program to assure it is running on the proper computer; if the identifier is not found, the primary software program terminates. Ideally the routine of checking for the identifier is done at several places within the primary software program to assure that the program has not be modified (i.e. the front of the program removed) to escape from the “key” identification component of the primary software program.

In alternative embodiments, the identifier is established using a downloaded secondary software program or by a download of the identifier from the manufacturer. This latter embodiment is ideally used for an Internet type of distribution system. In this context, the user purchases a copy of the primary software and during the download of the primary software program, a “key”/identifier is placed onto the user's computer.

Again, when the primary software is operating, it checks to see if the identifier or key exists and terminates should the identifier or key be absent.

In some embodiments, the identifier is stored on a removable medium, thereby forming a physical “key” which must be used when the primary software is to be operated. In this embodiment, the key is stored on a medium such as a magnetic card well known to those of ordinary skill in the art. Again, as the program operates, it checks for the identifier on the magnetic card and terminates operation if the identifier or the key does is not found.

This embodiment is also useful where the owner wants to assure that no one is using the computer without authorization. By simply removing the magnetic card (key), the programs within the computer using the key are rendered inoperative.

In one embodiment of the invention. The medium used to distribute the software combination is an combination of both Write Once Read Many (WORM) and a Compact Disk Read Write (CDRW). This provides a non-erasable section (WORM) for the primary software program (thereby protecting the software for later loading onto the computer); as well as an erasable section (CDRW) for the secondary software program (allowing the secondary program to be erased once it has been used to establish the identifier).

One embodiment of the invention addresses the issue of the use of “patches” to avoid security aspects of the targeted software. In this embodiment, a system for the protection of the software is created in which, during the downloading process, the overall length of the executable software is changed.

One technique for varying the executable length of a software package is to selectively add executable code to various places within the code. Another technique is to selectively delete executable code from the software package. In either case, the executable code that is either added or deleted is benign to the overall operation of the software package. Those of ordinary skill in the art readily recognize other techniques which will accomplish this objective.

A variety of embodiments are used to determine how much executable code is to be added/deleted from the software program. In one embodiment, the amount of executable code is randomly chosen; in another, the amount of executable code is based upon a unique indicia found in the computer itself (i.e. the serial number, the manufacture date, or an internally defined indicia); in yet another embodiment, the amount of executable code is arbitrarily chosen (i.e. based on the time of day or an internal pre-defined number).

In this way, while a single version of the software program is distributed, differing versions are created by the various users. This creates the need for a “pirate” wishing to avoid the security within the software through patches, to create a “patch kit” for an enormous number of versions of the same software package; thereby rendering the “patch kit” approach impractical.

In another embodiment of the invention, groupings or subroutines within the software are “shuffled” into new positions. This “shuffling” is done each time the software is used or at the initial download of the software into the operating computer. In this manner, a subroutine which performs the security aspect of the software is moved, thereby making the use of a “patch kit” difficult.

The invention, together with various embodiments thereof, will be more fully explained by the accompanying drawings and the associated descriptions thereof.

### DRAWINGS IN BRIEF

FIG. 1 pictorially illustrates the preferred embodiment which uses two mediums with the computer.

FIG. 2 illustrates an embodiment of the medium used to communicate the primary software program and the secondary software program.

FIG. 3 is a block diagram of the a computer used in the present invention.

FIG. 4 is a flow-chart of the download from the medium into the computer.

FIG. 5 is a flow-chart of the preferred operation of the secondary software program.

FIG. 6 is a flow-chart of a subroutine used in the primary software program.

FIG. 7 is a flow-chart of the general operation of the preferred embodiment for the anti-patch application.

FIGS. 8A, 8B, and 8C are flow charts of varying embodiments for the selection of the amount of executable code which is added and/or deleted from the targeted software package.

FIGS. 9A, 9B, and 9C graphically illustrate the transformation done to the targeted program by adding/deleting executable code segments.

FIG. 10 is a graphical illustration of a computer identifying where the download software may be resident.

FIG. 11 graphically represents the transformation applied in one embodiment of the invention.

### DRAWINGS IN DETAIL

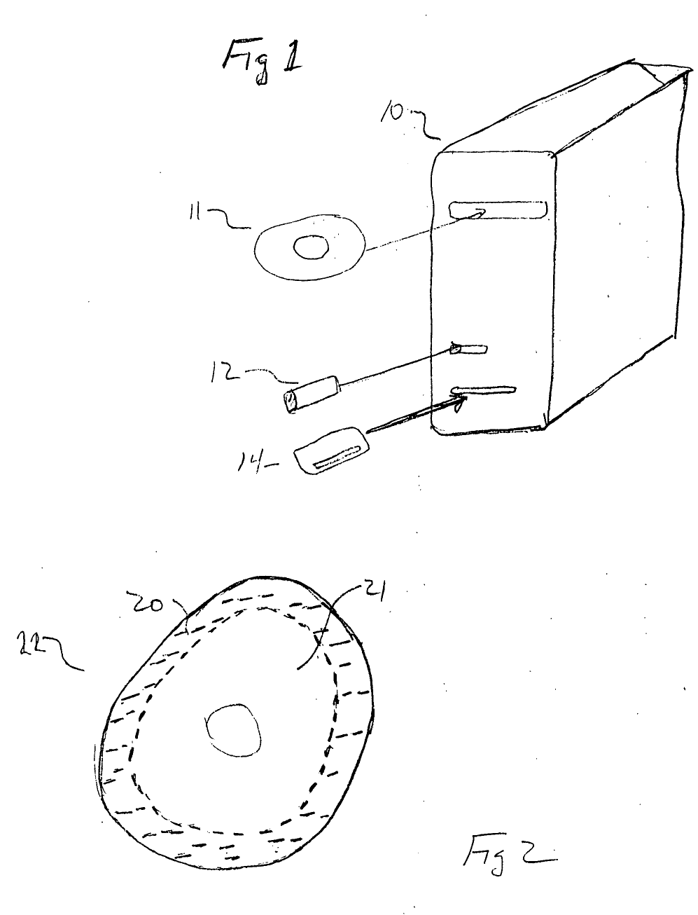

FIG. 1 pictorially illustrates the preferred embodiment which uses two mediums with the computer.

In this embodiment of the invention, computer 10 is adapted to receive a first medium 11 as well as a magnetic card 12. First medium 11 in this illustration is a CDRW which allows the primary software as well as the secondary software programs to be stored thereon.

Magnetic card 12 is used in the preferred embodiment, although any other erasable medium is also useable in this context (such as credit card 14). Other types of mediums which serve the purpose of the magnetic card 12 include, but are not limited to: CDRWs and floppy diskettes.

In the preferred embodiment, magnetic card 12 is used to hold the identifier used by the primary program and as such serves as a key. Note, in this manner, the two mediums are used in concert to obtain a working primary program. The user is able to move the primary software program to a second (or third, fourth, etc.) computer and have the primary software (such as a spread sheet) operate so long as the magnetic card 12 (“key”) is also used.

This feature also assures the user on the privacy of the primary software as the magnetic card 12, working as a key, provides an absolute barrier to unauthorized use of the software as the user is able to maintain physical control of the key; this eliminates the risky use of passwords and ID's for security.

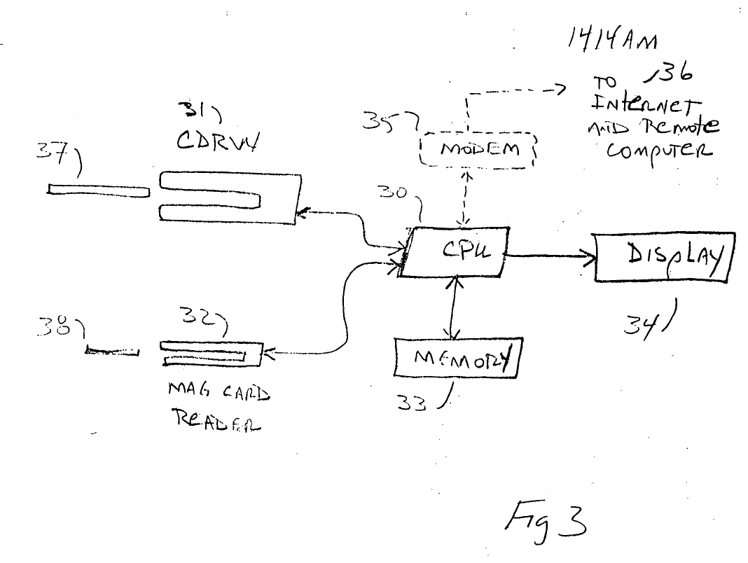

FIG. 2 illustrates an embodiment of the medium used to communicate the primary software program and the secondary software program.

In some situations, the use of a CDRW is not adviseable as the primary software may be “lost” or corrupted. In this type of situation, a compact disk 22 is segmented into two different sections: a CDRW section 20, and, a WORM section 21. These two section form an erasable section (CDRW 20) and a non-erasable section (WORM 21). This allows the secondary software program to be stored on the erasable section 20; and, the primary software program to be stored on the non-erasable section 21.

As outlined above, once the secondary software program has created the identifier/key, the program is erased from the erasable section 20; but, the primary software, stored on the non-erasable section 21, remains intact and can be used to recreate the primary software on the computer should the copy within the computer become corrupted.

FIG. 3 is a block diagram of the a computer used in the present invention.

While those of ordinary skill in the art readily recognize a variety of computer systems which will serve in this function, the block diagram of FIG. 3 illustrates some of the major components and the considerations which are useful in creating such a computer.

At the heart of the computer is the Central Processing Unit (CPU) 30. A CDRW drive 31 is used to read the first medium 37. This information is stored by CPU 30 onto memory 33 which works as a non-volatile memory of data. CPU 30 operates under software programs and as such is the “brains” when operating under both the primary software program and the secondary software program.

Magnetic card reader 32 is able to read/write onto magnetic card 38 as per the directions of CPU 30.

In some embodiments, the identifier as established by the secondary program, as discussed above, is stored in both memory 33 and magnetic card 38 by the secondary program. In other embodiments, the identifier is stored only on magnetic card 38 and is also resident in the primary software program.

The secondary program is read from CDRW 37 via CDRW reader 31 and stored in memory 33 in the preferred embodiment. In an alternative embodiment, the secondary software program is obtained from a remote computer via the Internet 36 using modem 35 or such other communications device. In yet another embodiment, a secondary software program is not used, rather, the identifier is obtained from a remote computer on the Internet 36 again using modem 35.

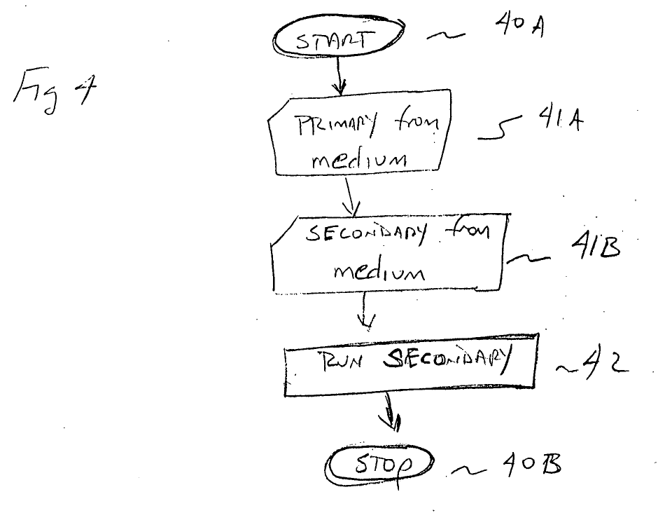

FIG. 4 is a flow-chart of the download from the medium into the computer. In this context, “download” is the reading of a program or data from one source and forming a copy of the program or data onto another medium or computer memory.

Once the download starts 40A, the primary software program is obtained from the medium 41A and is stored into the memory of the computer. In this context, using the example of FIG. 3, the primary software program is initially stored on CDRW 31.

The secondary software program is then downloaded 41B and is stored into the memory of the computer. The secondary software program is run 42 to establish the key or identifier within the appropriate locations and the copies of the secondary software program are erased; the programs stops 40B. At this point, the authorized user is able to run the primary program and the distributor of the primary software program is assured that only a single authorized copy of the software may be used.

FIG. 5 is a flow-chart of the preferred operation of the secondary software program.

As noted above, the secondary software program is used to establish the “key” or identifier which is used by the primary software program. In the preferred embodiment, the program starts 50A and withdraws a serial number for the computer 51 on which the program is operating 51A. While the preferred embodiment uses the serial number, the invention is not so limited as any identifier is useable, including, but not limited to a random number generated by the secondary software program. In the preferred embodiment, the identifier is unique to the computer and primary software program copy.

The next step is to obtain the serial number for the primary software program 51B. Using the two serial numbers, an identifier is formed 52A In this embodiment, the identifier is then stored on both the computer's internal memory as well as any “key” mechanism (such as a magnetic card or floppy diskette). The program then determines which memory and key is to be used for storage of the identifier 51C and the identifier is stored to the appropriate locations 53.

This sequence of steps allows the secondary software program to establish the key at the appropriate locations to comply with the structure of the actual computer being used. As example, some computers do not have the ability to read magnetic cards, but, they may have a floppy diskette drive, hence the floppy diskette becomes the key.

The secondary software program then erases its own copies from the non-volatile memory of the computer as well as from the medium upon which it was transferred (i.e. the CDRW discussed above) and the secondary software program stops 50B. Since the secondary software program is operating from volatile memory, when the operating copy of the secondary software terminates (50B), all copies of the secondary software program have been destroyed, thereby preventing the user from creating an unauthorized key.

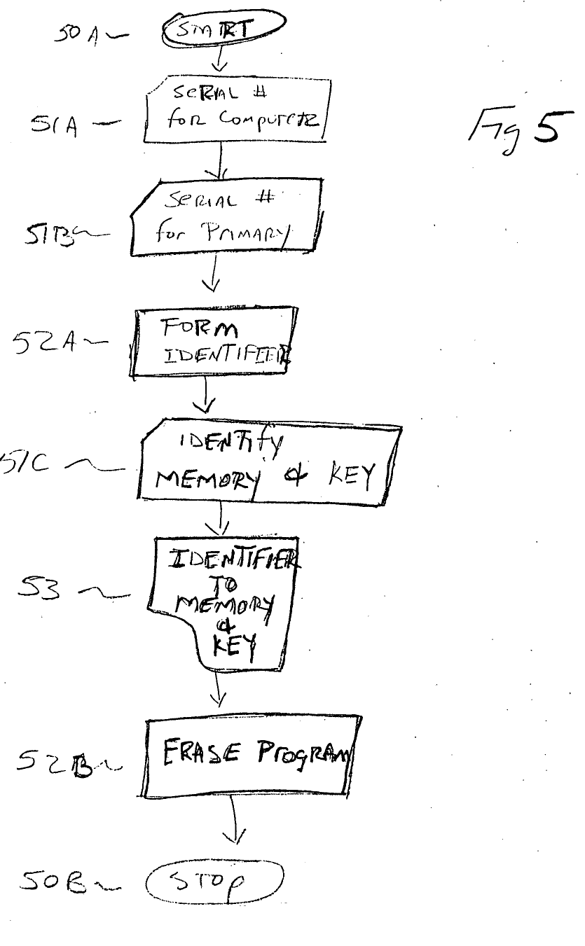

FIG. 6 is a flow-chart of a subroutine used in the primary software program.

This subroutine is embedded into the primary software program and is run periodically from the primary software program. The purpose of this subroutine is to assure the primary software program that it is operating on an authorized machine with authorized software.

Once the subroutine begins, it reads the identifier from the memory 61A of the computer. This identifier is stored in a location and is used to “mark” the computer itself.

In some embodiments, the identifier is not stored on the computer but is embedded as a data component within the primary software computer. In this embodiment, the identifier is simply used from the primary software data grouping 64 instead of reading the identifier from memory 61A. This embodiment allows the primary software program to be used on any computer provided the key is also present.

In either case, the identifier is then read from the key (such as the magnetic card) 61B.

The two read identifiers are then compared 62.

Note, in this embodiment, if either the computer memory or the magnetic card do not contain an identifier, then the comparison 62 yields a NO; also if the two identifiers are not identical, then a NO at comparison 62 is generated. In this case (NO), an error message is given to the user 63 and the primary software program stops 60C.

If the comparison 62 yields a YES, then the subroutine returns 60B to the primary software programs task.

In this manner, the primary software program only operates on the proper computer having the appropriate key.

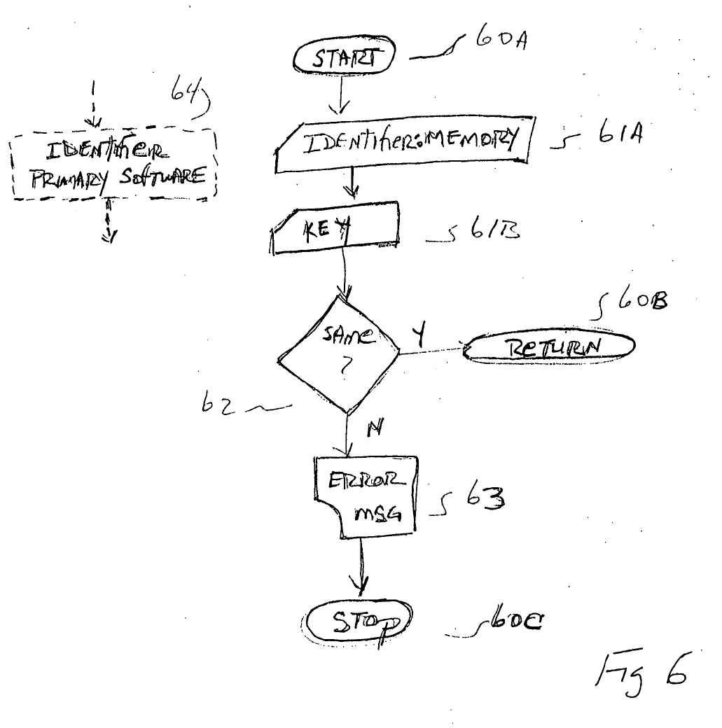

FIG. 7 is a flow-chart of the general operation of the preferred embodiment for the anti-patch application.

This embodiment of the downloading process is begun (start 70A) and the targeted software is obtained 74. The targeted software is an executable coded software package which is to be protected from “patch” piracy.

A variance is then established 71 which is used to adjust the executable code 72 within the software package. The variance defines the amount of executable code that is added or delted. Once the executable code has been modified, the modified executable code is then downloaded 73 to the computer memory and the download stops 70B.

The process outlined in this figure is but one of many methodologies obvious to those of ordinary skill in the art. The resultant is that the executable program within the memory of the computer does not necessarily match the code found in another computer for the same software package. This makes the task a “pirate” has in creating a patch all the more difficult.

As example, assume the download program creates over a hundred variations of the original software program for a thousand computer; the “pirate” must not only make over one hundred patches but must also identify which specific variation exists on a particular computer.

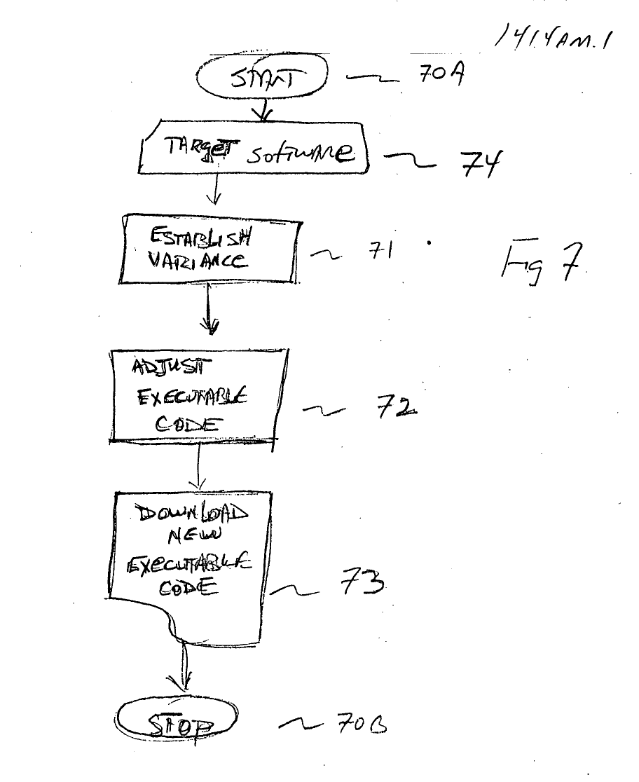

FIGS. 8A, 8B, and 8C are flow charts of varying embodiments for the selection of the amount of executable code which is added and/or deleted from the targeted software package. This relates to various techniques used to “establish a variance” (71) of FIG. 7.

Referring to FIG. 8A, this technique uses and identification from the computer 80A as a “key” to generate a random number 80B. This random number is used to establish the variance which is to be generated into the software program's executable code.

A variety of identification numbers from the computer are obvious to those of ordinary skill in the art, including, but not limited to: the serial number of the processor; the manufacture's serial number; and the date of manufacture.

FIG. 8B illustrates an embodiment which uses the time of day 80C as the key for the random number generator 80D. Again, the randomly generated number produces a variance which is applied to the executable code of the software program.

In FIG. 8C, the variance has been pre-selected from a data string within the download program. Each time the download program operates, the next value within the data string is chosen to serve as the variance.

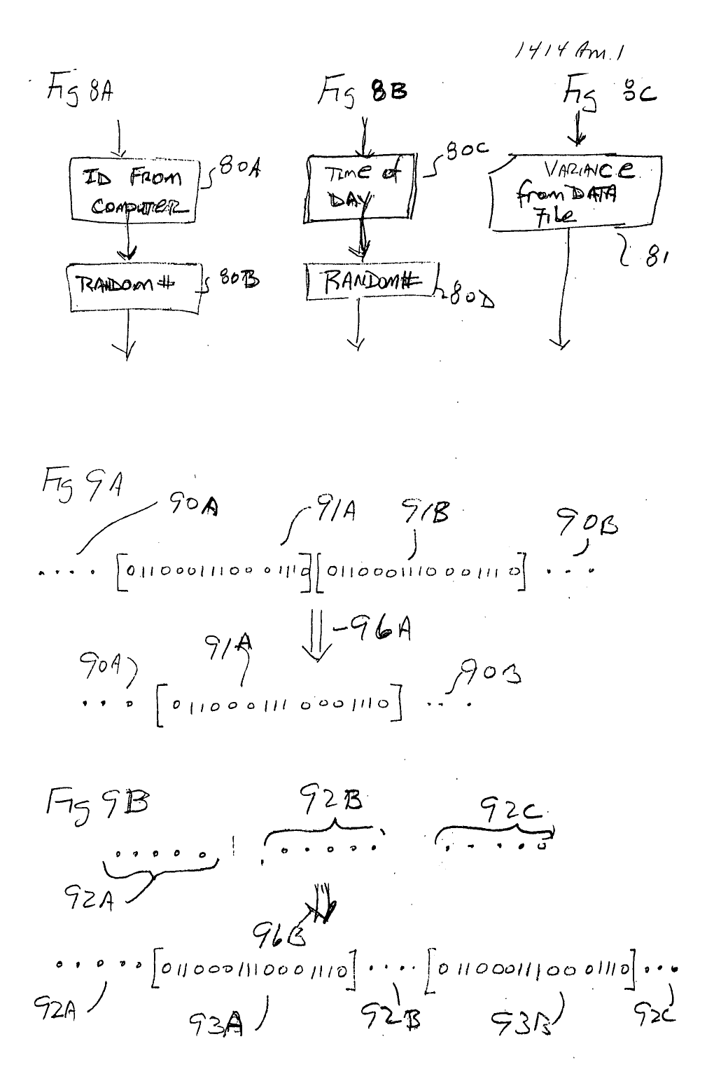

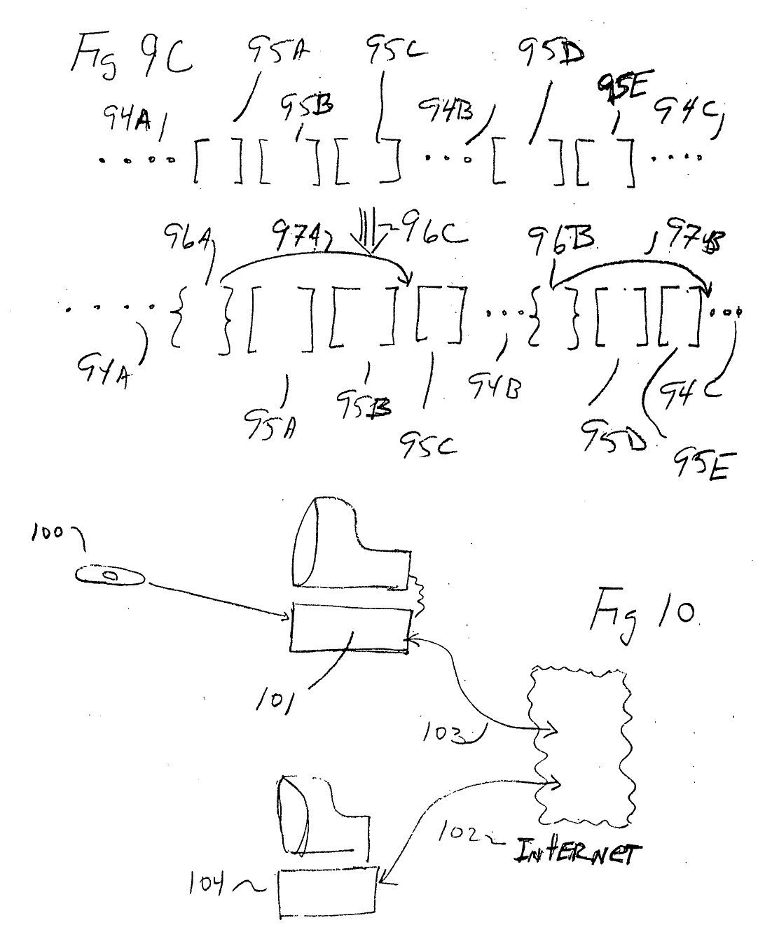

FIGS. 9A, 9B, and 9C graphically illustrate the transformation done to the targeted program by adding/deleting executable code segments.

Referring to FIG. 9A, the executable code from the software program consists of a series involving the active code 90A and 90B together with two segments 91A and 91B consisting of benign or non-functional code (such as a series of “go to” statements which lead eventually to the next statement). Benign segments 91A and 91B are identified using brackets (“[ ]”) for ease of illustration purposes.

In this illustration, transformation 96A removes benign segment 91B so that the executable code that is stored within the memory of the computer is segment 90A, benign segment 91A, and segment 90B. In this way, the overall length of the software program is modified.

Another transformation technique is illustrated in FIG. 9B. In this illustration, the executable code for the software program consists of segments 92A, 92B, and 92C. Transformation 96B inserts benign segments 93A and 93B into the code. The resulting executable code that is downloaded is: segments 92A, 93A, 92B, 93B, and 92C.

Still another technique is illustrated in FIG. 9C. For ease of illustration, the series of 0 s and 1 s (defining the benign segments) is omitted from between the brackets.

The executable software program consists of segment 94A, 94B, and 94C. Benign segments 95A, 95B, 95C, 95D, and 95C are also positioned within the original executable software.

During the transformation of the software program, patches 96A and 96B are selectively placed so that during operation the program skips 97A benign segments 95A and 95B to go directly to benign segment 95C; a similar skip 97B occurs because of patch 96B which causes benign segments 95D and 95E to be skipped in operation.

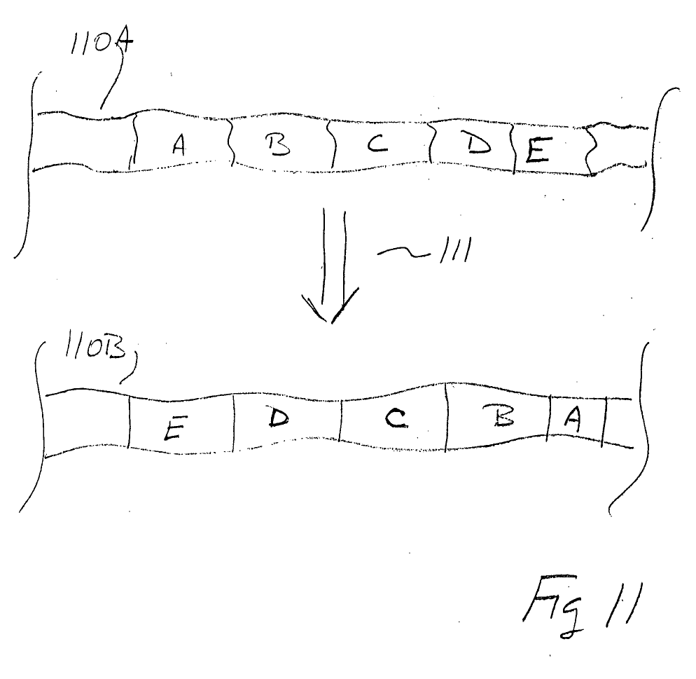

FIG. 10 is a graphical illustration of a computer identifying where the download software may be resident.

As shown in this illustration, the download program can be resident on either a removable storage medium 100 or resident within computer 101.

Another source of the download program is through the Internet 102 or other such distributed network of computers. The download program, in one embodiment, is communicated to computer 101 via Internet 102 from a source computer 104. In this embodiment, the download program delivered to computer 101 has been altered into its final form as outlined above.

In another embodiment of the invention, the download program is contained within a “digital container” such as that described by U.S. Pat. No. 6,629,150, entitled, “Platform and Method for Creating and Using a Digital Container” issued to Huded on Sep. 30, 2003; or U.S. Pat. No. 6,098,056, entitled “System and Method for Controlling Access Rights to and Security of Digital Content in a Distributed Information System, e.g. Internet” issued to Rusnak et al. on Aug. 1, 2000; both of which are incorporated hereinto by reference.

Where a “digital container” is used, ideally the software which is used to grant access to the download software is used to modify the download software as outlined above.

FIG. 11 graphically represents the transformation applied in one embodiment of the invention.

Download software 110A is shown having five subroutines (labeled “A”, “B”, “C”, “D”, and “E”). During the download process 111, the software is transformed to software 110B so that the order of these five subroutines is altered to the now “E”, “D”, “C”, “B”, and “A”. This transformation alters the position of each of the subroutines, thereby making “patch kits” impractical.

Note, the overall length of the software in this illustration is not altered, only the order of parts of the download program.

Even with this simple illustration of only five components which are “shuffled”, some 120 different variations now exist for the original software. With seven different components for the software, the number of possible variations grows to 5040.

It is clear that the present invention provides for an effective method to curtail the unauthorized copying of software.

What is claimed is:

1. A system for the protection of software from unauthorized copying comprising:
a) a medium having stored thereon a first software program having a first length;
b) a computer having a non-volatile memory; and,
c) download means for,
1) copying said software program,
2) selectively creating a second software program based upon said first software program, said second software program having a second length different from the first length of said first software program, and
3) storing said second software program in said non-volatile memory.

2. The system according to claim 1,
a) wherein said first program is in executable form; and,
b) wherein said download means includes means for selectively adding an executable portion into said first software program to create said second software program.

3. The system according to claim 2, wherein said executable portion has a length defined by said download means.

4. The system according to claim 3, wherein the length of said executable portion is arbitrarily chosen by said download means.

5. The system according to claim 3, wherein the length of said executable portion is established by said download means based upon an indicia within said computer.

6. The system according to claim 5, wherein said indicia within said computer is unique to said computer.

7. The system according to claim 5, wherein said download means is resident within said computer.

8. The system according to claim 5, wherein said download means is resident within said medium.

9. A system for the protection of software comprising:
a) a medium having stored thereon a first executable software program having a first length;
b) a computer having a memory; and,
c) download means for,
1) selectively creating a second executable software program based upon said first executable software program and having a second length different from the first length of said first executable software program, and
2) storing said second executable software program in said memory.

10. The system according to claim 9, wherein said download means includes means for selectively adding an executable portion into said first executable software program to create said second executable software program.

11. The system according to claim 10, wherein said executable portion has a length defined by said download means.

12. The system according to claim 11, wherein the length of said executable portion is established by said download means based upon an indicia within said computer.

13. The system according to claim 12, wherein said indicia within said computer is unique to said computer.

14. The system according to claim 13, wherein said download means is resident within said computer.

15. The system according to claim 12, wherein said download means is resident within said medium.

16. A downloading system comprising:
a) means for selectively creating a second executable software program based upon a first executable software program, said second executable software program having a length different from a length of said first executable software program; and,
b) means for storing said second executable software program in a memory of a computer.

17. The system according to claim 16, wherein said means for selectively creating includes means for selectively adding an executable portion into said first executable software program to create said second executable software program.

18. The system according to claim 17,
a) further including means for reading an indicia from said computer; and,
b) wherein said executable portion has a length established by said indicia.

19. The system according to claim 18, wherein said indicia within said computer is unique to said computer.
